(19) United States
(12) Patent Application Publication
(10) Pub. No.: US 2024/0377187 A1
(43) Pub. Date: Nov. 14, 2024

(54) GUIDE APPARATUS AND METHODS

(71) Applicant: Joseph George POOLE, Kent (GB)

(72) Inventor: Joseph George POOLE, Kent (GB)

(21) Appl. No.: 18/688,625

(22) PCT Filed: Sep. 2, 2022
(86) PCT No.: PCT/GB2022/052242

§ 371 Date: Mar. 1, 2024

(30) Foreign Application Priority Data
Sep. 3, 2021 (GB) 2112556.2

(51) Int. Cl. G01B 11/14

(52) U.S. Cl. CPC G01B 11/14

(57) ABSTRACT

A guide apparatus (110) comprising a support body (112); an actuator (166); control means (168); a plurality of light emitting elements (114) connected to the support body (112) and at least one of the light emitting elements (114) being movable by the at least one actuator (166) relative to the support body (112), each light emitting element (114) being configurable to emit a beam of light onto a target surface (56), so that the position of an opening and/or of a plurality of non-overlapping fixture mounting points (58) for a fixture (42) can be simultaneously projected on the target surface (56) by the light emitting elements (114;214). A guide apparatus (10) comprising: a dimensionally-adjustable support body (12) adjustable in at least two dimensions; and a plurality of light emitting elements (14).

The present invention relates to a guide apparatus which aids a user in accurately positioning a fixture on a target surface, such as a ceiling, and/or which can display the position of an opening to be cut in the target surface. The present invention also relates to a method of indicating the position of an opening and/or installing a fixture to a target surface.

To install a fixture on a surface, a user generally needs to insert an attachment into the surface to retain the fixture in position. For example, a light fixture may comprise a base having an opening. A hole is formed in a ceiling and a screw is inserted into both the opening of the light and into the hole.

Forming the hole, holding and positioning the fixture and connecting the attachment simultaneously, whilst an option, is impractical. The user may therefore decide to do some or all of steps sequentially. The attachment may be fixed in place before connecting the fixture thereto. Alternatively, a hole may be formed in the ceiling before the fixture is positioned and the attachment connected to both the hole and fixture.

If a plurality of attachments is required, the surface holes and/or the attachments need to be accurately positioned both relative to each other and relative to the fixture openings, requiring careful measuring, and therefore time.

The location of the fixture is typically carefully selected for aesthetic and/or practical purposes. For example, a light might be positioned centrally in a room. Careful selection of the location typically requires measuring the distance from one or more walls. If using a tape measure, the tape measure may bend if extended too far and suspended above the ground. The tape measure may not even extend sufficiently far, depending on the distance to a wall. Furthermore, the tape measure generally needs to extend perpendicularly to a wall to give an accurate reading. Such an angle is difficult to estimate, particularly from a distance.

If the fixture is attached to a high surface, the user has to use a step, ladder or elevated platform. Positioning, scaling and repositioning the ladder increases the time taken to install the fixture. The health and safety risk is also increased due to the height.

Marking the position of the hole or holes is typically done with a pencil or pen, which can be easily dropped. If the measurements are incorrect, pencil or pen markings may remain visible on the mounting surface, which is undesirable.

The present invention seeks to provide a solution to these problems.

According to a first aspect of the present invention, there is provided a fixture-installation guide apparatus comprising: a dimensionally-adjustable support body which is adjustable in at least two dimensions; and a plurality of light emitting elements which are selectably positionable on the dimensionally-adjustable support body, each light emitting element being configurable to emit a beam of light onto a mounting surface for a fixture, so that the position of a plurality of non-overlapping fixture mounting points can be simultaneously projected on the mounting surface by the light emitting elements. The guide apparatus helps a user to install a fixture, by projecting light onto the mounting surface. The light indicates all or at least a subset of mounting points simultaneously, in other words, where the attachments are to be engaged with the mounting surface. As the measurements may be taken from ground-level, the guide apparatus increases the safety of installing a fixture by negating the need to measure the distance from the mounting point to a further surface from a high position. Measuring distances between mounting points can be omitted entirely, thereby simplifying the process and increasing the speed of installation. The adjustability of the body in two or three dimensions enables the guide apparatus to be used with a range of different fixtures. Adjustability in two or three dimensions may enable the guide apparatus to be collapsible or foldable. A more compact guide apparatus may be more portable and thus, easier to transport. It could easily be envisioned however that the guide apparatus may only have one light emitting element. Preferably, the dimensionally-adjustable support body may comprise a plurality of elongate elements connected to each other and movable relative to each other. The elongate elements enable the support body or part thereof to be adjustable in two or three dimensions. Beneficially, at least two elongate elements may each comprise a rail element, and at least one of the said light emitting elements may be receivable in or on each rail element. A rail element may provide a continuous range of possible positions for each light emitting element. Advantageously, the engagement of at least two said light emitting elements with the rail elements may orient the light emitting elements so that the light emitting elements may have the same light-emitting orientation as each other. Preferably, the dimensionally-adjustable support body may extend in a prevailing plane and at least one said light emitting element may be oriented to emit light perpendicularly to the said prevailing plane. The guide apparatus may be positionable on the ground and project light perpendicularly thereto.

Additionally, at least one said light emitting element may be slidably engageable with the rail element via slidable engagement portions. A light emitting element is easy to move. Furthermore, at least one said rail element may comprise a contact element which may be electrically energisable and at least one said light emitting element may be powered via the contact element. Optionally, at least one said light emitting element may comprise a conductive brush for contacting the contact element. The light emitting element does not require its own power-source. A simpler light emitting element may be cheaper and/or easier to replace. Alternatively, at least one light emitting element may comprise an inductive charging member for being electrically energised by the contact portion via induction. In a further alternative, at least one light emitting element may comprise a portable power source. Induction or a portable power source may increase the safety as preventing or inhibiting direct access to an exposed, electrically-energised track or wire. Beneficially, at least one elongate element may further comprise a measurement means for measuring the position of a light emitting element relative to the at least one elongate element and/or the position of elongate elements relative to each other. A measurement means, such as a scale, may enable measuring of distances, if required, for instance between two light emitting elements on the same rail element. The position of one elongate element along a longitudinal extent of a further said elongate element can be measured. Preferably, at least two of the said plurality of elongate elements may be connected to each other at a pivot point such that said at least two elongate elements may be pivotably movable relative to each other to enable the support body to be adjustable in at least two dimensions. Beneficially, the said plurality of elongate elements may comprise four elongate elements pairwise pivotably connectable with each other, forming at least a first pivot point, a second pivot point, a third pivot point and a fourth pivot point. Optionally, the guide apparatus may further comprise a pivot-point guide channel along which any of: the pivot point, the first pivot point, the second pivot point, the third pivot point and the fourth pivot point may be slidable. Optionally the pivot-point guide channel may be provided on any elongate element of the said plurality of elongate elements and/or on the body. Alternatively, a first elongate element of the said plurality of elongate elements may have a slidable engagement portion engageable with a complementary engagement portion of a second elongate element of the said plurality of elongate elements such that the first and second elongate elements may be translatable relative to each other to enable the support body to be adjustable in at least two dimensions. Pivotable and/or translatable elongate elements enables the shape, size or configuration of the support body to be adjusted as required to fit a range of fixtures. Pivotable and/or translatable elongate elements may also enable the guide apparatus to be compact, increasing storage and/or portability. Preferably, at least one light emitting element of the said plurality of light emitting elements may comprise a laser for emitting laser light. Beneficially, the laser may be configurable to project a beam of laser light, the beam having a circular cross-section. Alternatively, the laser may be configurable to project a beam of laser light, the beam having a pattern in cross-section. Furthermore, the pattern may include a cross. A dot of laser light or a cross may provide a clear indication of the position of the mounting point. Preferably, the fixture-installation guide apparatus may further comprise a spirit-level provided in or on the support body and/or in or on a light emitting element. The spirit-level may help a user check that the horizontal and/or vertical alignment of the guide apparatus.

Beneficially, the fixture-installation guide apparatus may further comprise a ground-engagement portion comprising an anti-slip portion. The risk of accidental displacement of the guide apparatus may be reduced. Additionally, the fixture-installation guide apparatus may comprise a plurality of said ground-engagement portions and at least one said ground-engagement portion may be telescopic to enable a height of the ground-engagement portion to be adjustable for enabling adjustment of the pitch of the support body. Adjustability of the height of the ground-engagement portion may enable an incorrect alignment horizontally and/or vertically to be corrected. Optionally, the fixture-installation guide apparatus may further comprise a secondary light emitting element, configurable to project a light beam perpendicularly to a light beam from a light emitting element of the said plurality of light emitting elements. Additionally, the fixture-installation guide apparatus may further comprise a tertiary light emitting element, configurable to project a light beam perpendicularly relative to a light beam from both the secondary light emitting element and a light emitting element of the said plurality of light emitting elements. In other words, the light from the tertiary emitting element is normal to the light beams from the light emitting element and the secondary light emitting element. The secondary and tertiary light emitting elements may further help the user position the guide apparatus with respect to another surface or item, for example by allowing the user to align a tape measurer with the light emitted by the secondary and tertiary light emitting elements.

According to a second aspect of the invention, there is provided a method of indicating the position of mounting points for fixture attachments on a mounting surface, the method comprising the steps of: a] providing a fixture-installation guide apparatus having repositionable light emitting elements; b] positioning the light emitting elements relative to each other so that a two-dimensional spatial distribution of the light emitting elements matches a spatial distribution of the attachment points of a fixture to be mounted onto the mounting surface; c] positioning the fixture-installation guide apparatus on a ground surface facing the mounting surface and activating the light emitting elements to emit light so that each light emitting element projects light onto the mounting surface to indicate the position of mounting points for fixture attachments on the mounting surface. Preferably, the fixture-installation guide apparatus of step a] may be a fixture-installation guide apparatus in accordance with the first aspect of the invention.

Beneficially, the fixture of step b] may be an air-conditioning unit such that the method may be a method of indicating the position of mounting points for attachments for an air-conditioning unit on a mounting surface. The mounting surface may be a ceiling. The installation process is simpler, and therefore faster as the user is not required to measure distances between the mounting points, particularly not at any height.

According to a third aspect of the invention, there is provided a guide apparatus, comprising a support body; an actuator associated with the support body; control means for controlling the actuator; a plurality of light emitting elements connected to the support body and at least one of the light emitting elements being movable by the at least one actuator relative to the support body, each light emitting element being configurable to emit a beam of light onto a target surface, so that the position of an opening and/or or a plurality of non-overlapping fixture mounting points for a fixture can be simultaneously projected on the target surface by the light emitting elements. The actuator is adapted or configured to position or reposition a light emitting element or part thereof automatically, without requiring the user to manually move the light emitting element. The movement may as a result be more precise and/or controlled.

Beneficially, the actuator may include a pivot axis around which the actuator may be pivotable such that the at least one light emitting element may be pivotably movable relative to the support body. The actuator may actively re-orient a light emitting element in a controllable manner. Being pivotably rotatable around a single axis may be easier to configure and/or program than rotatability around a plurality of axes. Advantageously, the actuator may further include an arcuate edge and a wheel engageable with the arcuate edge for driving the motion of the arcuate edge when the wheel rotates. Optionally, one or both of the wheel and the arcuate edge may comprise teeth. Rotation of the, optionally toothed, wheel can reliably and in a controlled manner rotate the arcuate edge around the pivot axis. Furthermore, the actuator may include an actuator portion which may be pivotable around at least two non-parallel and non-colinear pivot axes such that the least one light emitting element may be rotatably movable in a plurality of dimensions relative to the support body. The actuator being pivotable around a plurality of pivot axes provides a greater freedom of motion. Beneficially, the support body may further comprise a movable support element to which at least one light emitting element may be mounted. Additionally, the apparatus may further comprise a further actuator, the movable support element being movable by the further actuator. More preferably, the movable support element may be rotatable around an axis. The movable support element provides an additional degree of freedom. The further actuator provides automation and greater control over the motion of the movable support element.

Preferably, the control means may comprise a calculating element for calculating a required position and/or orientation of a light emitting device of the at least one light emitting element. Optionally, the calculating element in-use may calculate a required movement of the light emitting device when the light emitting device is not in the required position and/or orientation.

Preferably, the apparatus may further comprise a height-measurement device and/or a distance measurement device for measuring a distance between the apparatus and the target surface. Additionally, the distance-measurement device may include at least two distance sensors. Furthermore, each distance sensor of the at least two distance sensors may have a distance-finding axis and the distance-finding axes of at least two of the distance sensors may be parallel for measuring the distance to a common surface. A plurality of distance sensors may measure the distance to a plurality of surfaces simultaneously if the distance sensors are oriented towards distinct surfaces. If oriented towards the same surface, the distance sensors can detect whether they are equidistant from and/or perpendicular with the surface.

Preferably, the apparatus may further include a user-interface. Optionally, the user-interface may include a screen. The user can input commands and/or receive an output, such as a distance reading or dimensions of the opening and/or fixture, via the user-interface.

Preferably, at least two light emitting elements may each have a light emitting device, each light-emitting device may have a light emitting aperture that may be elongate along an aperture axis for projecting light in the form of a line onto the target surface so that the lines may indicate a position of an opening and/or an intersection of the lines may indicate a fixture mounting point on the target surface. Two lines may be made to intersect to indicate a fixture mounting point and/or a corner of an opening. The lines may indicate the outline of the opening. Projecting a line rather than a circle means the actuator need only be pivotable around one axis instead of two. In turn, this may simplify the design of the apparatus, and facilitate manufacturing. As it is easier to calculate any required movement of the actuator, the accuracy of projection may be improved.

According to a fourth aspect of the invention, there is provided a method of indicating the position of an opening and/or the position of mounting points for fixture attachments on a target surface, the method comprising the steps of: a] providing a guide apparatus having repositionable light emitting elements and an actuator, optionally in accordance with the third aspect; b] positioning the guide apparatus on a surface, positioning and/or orienting at least one of the light emitting elements via the actuator so that the position of an opening is indicated by beams of light and/or the two-dimensional spatial distribution on the target surface of a plurality of non-overlapping fixture mounting points indicated by beams of light emitted by the light emitting elements matches a spatial distribution of the attachment points of a fixture to be mounted onto the target surface, and activating the light emitting elements to emit light so that each light emitting element projects light onto the target surface. The light emitting elements can be reliably and automatically orientated by an actuator to project onto a target surface, which is preferably a ceiling, the location of one or more fixture mounting points and/or the position of an opening. Each light emitting element may be moved, preferably by being pivoted, away from and/or towards a vertical orientation if required.

The invention will now be more particularly described, by way of example only, with reference to the accompanying drawings, in which:

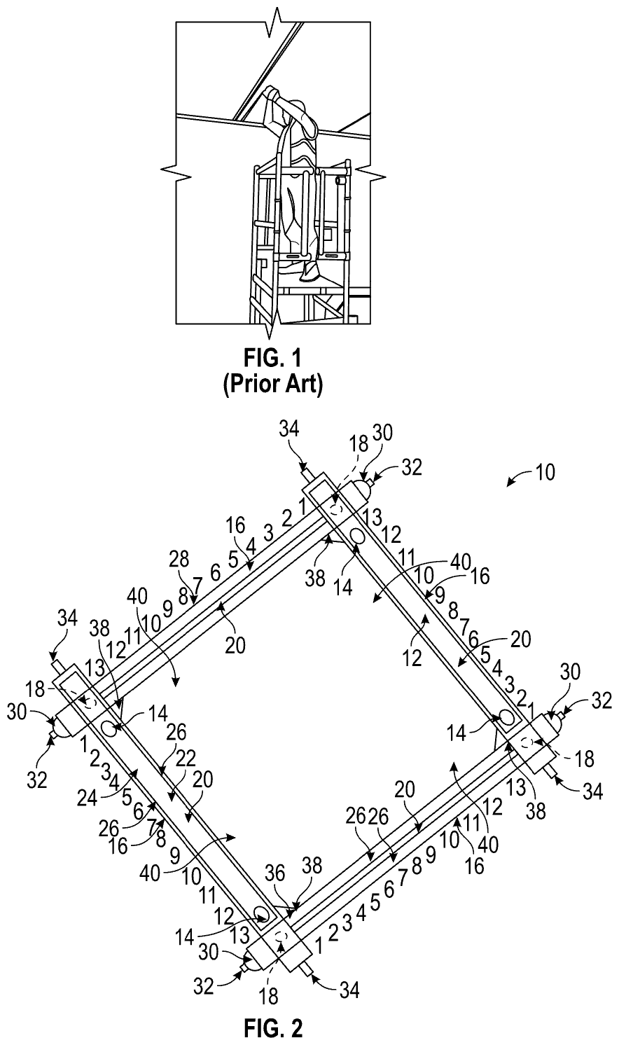

FIG. 1 shows an illustration of the method employed in the prior art to locate and mark the position of a mounting point on a ceiling;

FIG. 2 shows a plan representation of an embodiment of a fixture-installation guide apparatus in accordance with the first aspect of the invention;

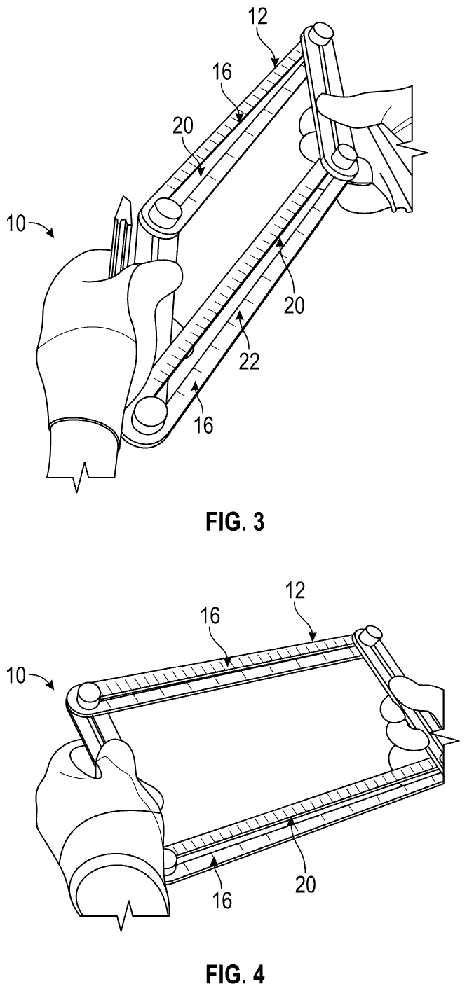

FIG. 3 illustrates a perspective view of the fixture-installation guide apparatus of FIG. 2, with all light emitting elements omitted for clarity, in-use in accordance with the second aspect of the invention, in a starting condition;

FIG. 4 shows a perspective view of the fixture-installation guide apparatus of FIG. 3, in-use, after being reconfigured into a use condition;

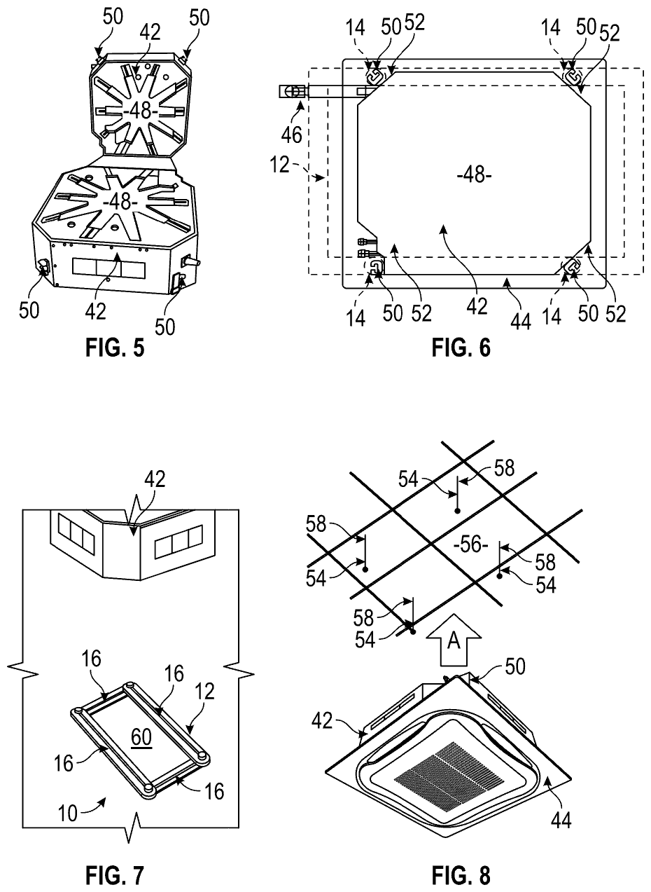

FIG. 5 is a perspective view of part of two fixtures, prior to installation on the ceiling;

FIG. 6 is a plan representation of a fixture of FIG. 5 overlaid with the dashed outline of a body and of four light emitting elements of the fixture-installation guide apparatus of FIG. 2;

FIG. 7 shows a perspective view of the fixture-installation guide apparatus of FIG. 3, in-use in accordance with the second aspect of the invention, with light emitting elements omitted for clarity, in position on the ground;

FIG. 8 illustrates a perspective view of four attachments connected to and extending from the ceiling after the positions of the four mounting points have been identified using the fixture-installation guide apparatus of FIG. 2, and the fixture of FIG. 6 being moved towards the ceiling, to engage with the four attachments;

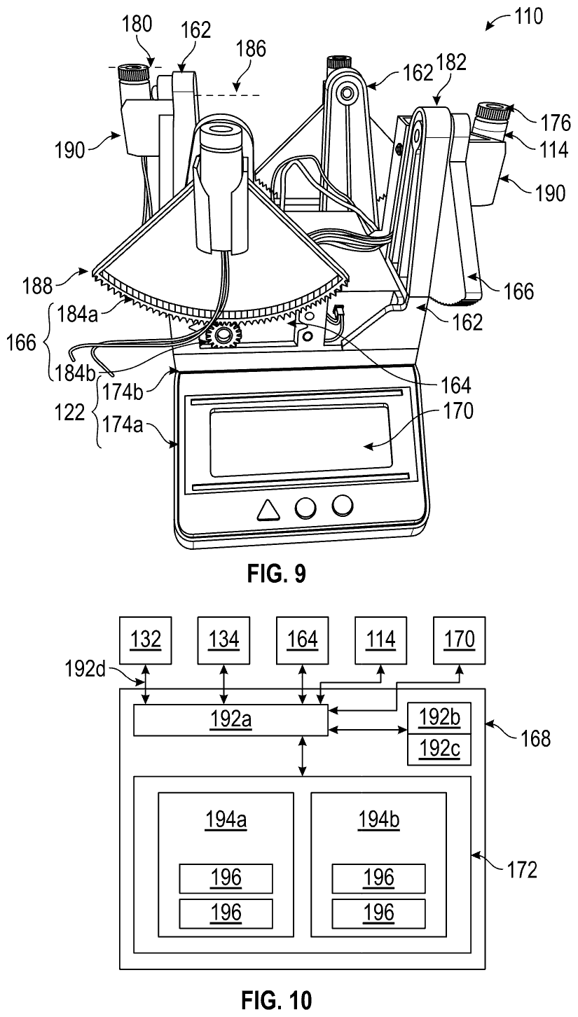

FIG. 9 shows a second embodiment of a guide apparatus in accordance with the third aspect;

FIG. 10 is a schematic representation of a control means of the guide apparatus of FIG. 9, in use in communication with a secondary light emitting element, a tertiary light emitting element, a power source, a light emitting element and a user-interface of the guide apparatus;

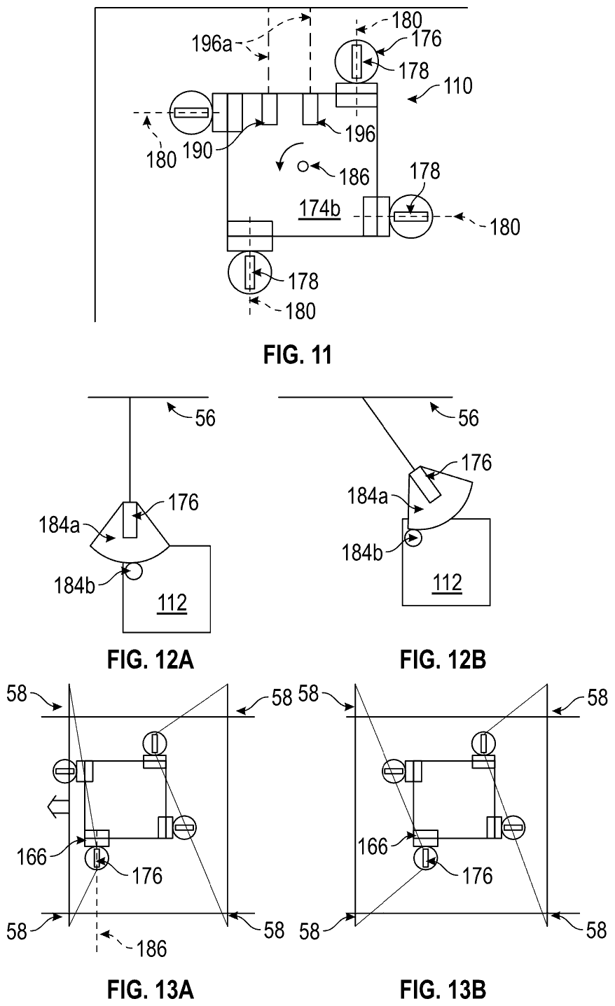

FIG. 11 is a top plan view of the guide apparatus of FIG. 9, in-use adjacent to a corner formed of two surfaces, wherein each distance sensor of a pair of distance sensors of the guide apparatus measures a distance to a common said surface;

FIG. 12a illustrates a side view of a support body, a light emitting device and an actuator of the guide apparatus of FIG. 9, in-use, emitting a beam of light vertically onto a target surface;

FIG. 12b shows the guide apparatus of FIG. 12a, in-use, after the actuator has pivoted the light emitting device such that the emitted beam of light is at angled relative to vertical;

FIG. 13a illustrates a cut-away top plan view of the guide apparatus of FIG. 9 in-use, with each light emitting device projecting a beam of light onto a target surface, the target surface cut away for clarity, and one of the light emitting devices being pivoted by its actuator so that the emitted beam of light by the pivoted light emitting device is repositioned on the target surface;

FIG. 13b shows the guide apparatus of FIG. 13a, in-use, after the light emitting device has been pivoted;

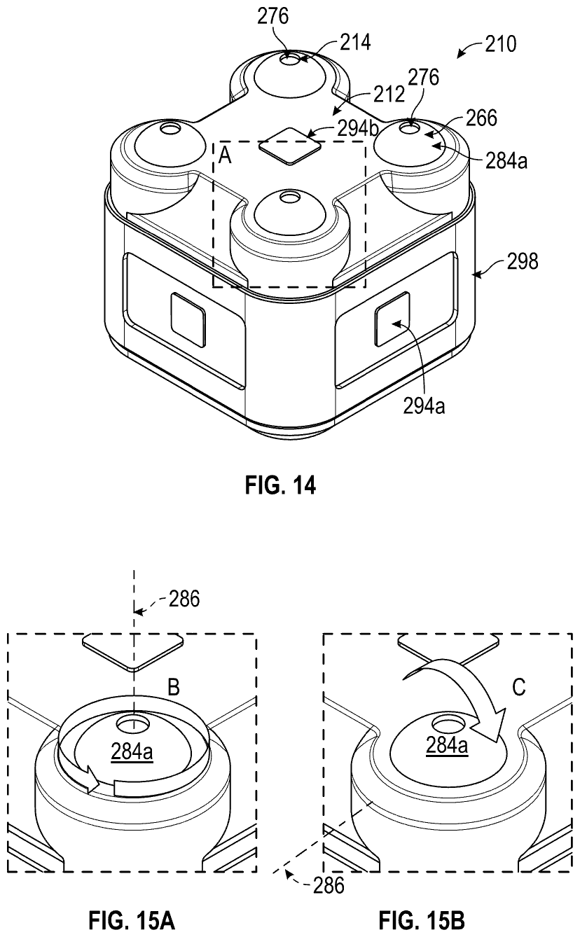

FIG. 14 illustrates a third embodiment of a guide apparatus in accordance with the third aspect;

FIG. 15a shows a close-up representation of box A of FIG. 14, with an actuator portion of the guide apparatus in-use rotating about a first pivot axis; and

FIG. 15b shows the actuator portion of FIG. 15a in-use rotating about a second pivot axis.

Referring to FIG. 1, there is shown the prior art in which a user is on an elevated platform, measuring and marking on the ceiling the position of a mounting point for a fixture attachment, using a tape measure. The tape measure is shown as starting the bend. Furthermore, the user must estimate by eye that the tape measure is orthogonal to the wall.

Referring to FIG. 2, there is shown a guide apparatus, indicated generally at 10 in accordance with the present invention. The guide apparatus 10 in-use enables a user to install a fixture and/or mark the position of an opening to be cut in a surface more easily and/or more quickly. Thus, the guide apparatus 10 may be referred to as a fixture-installation guide apparatus, a guiding apparatus or an indicating apparatus. The guide apparatus 10 may comprise metal, plastics, wood, rubber, glass, fibreglass, carbon fibre, any other suitable material, or any combination thereof. The guide apparatus 10 includes a body 12, and at least one, and more preferably a plurality of light emitting elements 14, although either feature may be omitted and/or a plurality provided.

The body 12 provides a support for the light emitting elements 14. The body 12 may be referred to as a support body 12. The body 12 also enables the light emitting elements 14 to be selectably positionable relative to each other. Each light emitting element 14 is preferably movable relative to the body 12, but the, each or at least one light emitting element may be non-movable, such as fixed, relative to the body or any part thereof. Thus, each light emitting element 14 is preferably selectably positionable and/or repositionable in, on or relative to the support body 12.

The body 12 itself is preferably adjustable but non-adjustable or part adjustable may be options. More preferably, the body 12 is adjustable in at least two dimensions. In other words, any of the: shape, size, and configuration of the body 12 in a two-dimensional plane may be altered. For example, the size of the body 12 may be increased or reduced to reposition or enable repositioning of a first light emitting element relative to another. Thus, the body 12 may be referred to as a dimensionally-adjustable support body 12. The body 12 may even be adjustable in three dimensions. In other words, any of the: shape, size, and configuration of the body 12 in a three-dimensional volume may be altered. The body 12 includes at least one elongate element 16, but elongate elements may be omitted entirely. In the shown embodiment, there are four elongate elements 16.

Each elongate element, mechanism or arm 16 may be linear or substantially linear, but non-linear may be an option, such as curved or part curved. Each elongate element 16 has a longitudinal extent, a width and a depth. Each elongate element 16 is square or rectangular in lateral or transverse cross-section, and rectangular in longitudinal cross-section, side and plan view, but non-square or non-rectangular in any cross-section or view may be options. Any end of any elongate element 16 may optionally be at least partly rounded or chamfered.

At least one, and preferably each elongate element 16 is connected or connectable to at least one further said elongate element 16. At least one of, and more preferably each elongate element 16 is preferably movable relative to one or more other elongate elements 16. In the shown embodiment, each elongate element 16 is connectable or connected to two other elongate elements 16, but any elongate element may be connected or connectable to none, one, or more than two elongate elements. Two or more connected elongate elements 16 are preferably non-colinear but this option may be envisioned. The elongate elements 16 and/or the body 12 may optionally be considered to form, define and/or extend in a prevailing plane.

At least two elongate elements 16 are connected to each via a fastener and/or engagement portions forming a pivot, pivot axis or pivot point 18. The pivot points 18 are illustrated as a dashed circle in FIG. 2. Such elongate elements 16 are pivotable relative to each other. This enables the support body 12 to be adjustable in two and/or three dimensions. Deformability in three dimensions may be provided, for example, by having pivots with non-parallel and non-colinear axes. The position of the pivot point 18 may be selectable. A pivot point 18 may be provided at or adjacent an end of an elongate element and/or spaced-apart therefrom.

In the shown embodiment, all elongate elements 16 of the body 12 are pairwise pivotably connectable with each other. The elongate elements 16 thus form a plurality of pivot points. As there are four elongate elements 16, four pivot points are formed, which may be referred to as first pivot point, second pivot point, third pivot point and fourth pivot point. Similar incremental number may be provided for a smaller or greater number of pivot points.

Preferably, each elongate elements 16 is non-translatable relative to the elongate element or elongate elements 16 it is connected or connectable to, but this alternative may be envisioned. In other words, each pivot point 18 is preferably fixed.

The body 12 further comprises a light-engagement means or mechanism for engaging the at least one light emitting element 14. The light-engagement means in the first embodiment includes at least one and more preferably a plurality of rails 20 but any alternative to a rail may be envisioned. At least one light emitting element 14 is engageable, directly or indirectly, with a said rail 20.

Each rail, rail element or runner 20 is preferably in, on or associated with an elongate element 16. All or any number of the elongate elements 16 may comprise a rail 20. The rail 20 may be engageable, engaged or integrally formed with the elongate element 16. Preferably, the rail 20 extends along or through a depth of the elongate element 16 but this is optional. For instance, a rail may only extend part of the depth of the elongate element. A rail may even be receivable on or around an elongate element.

At least one rail 20 and/or at least one elongate element 16 is preferably at least 30 cm long, although less than 30 cm may be an option. More preferably, at least one rail 20 and/or elongate element 16 is preferably at least 100 cm, and more preferably at least 200 cm long. In the preferred embodiment, at least one rail 20 and/or elongate element 16 is at least 244 cm or 8 feet long. Preferably, the length of an elongate element 16 is fixed, but non-fixed may be an option. For example, an elongate element may be stretchable or expandable, such as telescopically expandable.

In the preferred embodiment, the elongate element 16 and/or rail 20 comprises a volume, recess, space, cavity 22 for receiving at least part of a light emitting element 14. The volume 22 may be accessible by at least one, and more preferably two openings or gaps 24. Each opening 24 may be accessible from a different side or different surfaces of an elongate element 16 and/or rail 20. More preferably, each opening 24 is on opposing sides or surfaces of an elongate element 16 and/or rail 20. In other words, the volume 22 may be or be substantially a through bore or slit extending through the depth of the elongate element 16 and/or rail 20. The elongate element 16 and/or rail 20 may optionally have one or more flanges 26 adjacent to the or at least one said opening 24.

The flange or flanges 26 narrow the said opening 24. The dimensions of the opening 24 may prevent or inhibit insertion and/or removal of a light emitting element 14 therethrough. However, the opening 24 preferably allows light therethrough. Optionally, the at least one flange may be formed of a light-transmittive material, to enable light transmission therethrough, such as glass, transparent plastics, and/or translucent plastics.

Preferably, the engagement of at least two said light emitting elements 14 with the rail or rails 20 preferably orients the light emitting elements 14 so that the light emitting elements 14 have the same light-emitting orientation as each other.

Optionally, at least one said rail 20 or part thereof, such contact element or portion is electrically energisable. The contact element may be a track or wire. The advantage of this feature will be hereinafter explained. It may even be envisioned that one or all said openings may be omitted such that the cavity may be partly or fully enclosed, preferably by a light-transmittive wall. This may increase security by preventing or inhibiting access to an electrically energised portion of the rail 20.

Each light emitting element or light emitter 14 is able to, adapted to, configured or configurable to emit light in-use. The, each or at least one said light emitting element 14 is receivable in, on, or through a said rail 20. Each light emitting element 14 is preferably positionable and/or repositionable relative to a said rail 20 but any or all light emitting element may be non-repositionable, such as fixed, relative to the rail. In other words, a first said light emitting element is movable along the rail element for adjusting the position of the first said light emitting element, and/or the light projected onto the target surface, also referred to as a mounting surface by the first said light emitting element relative to a second said light emitting element and/or the light projected thereby. Each light emitting element 14 comprises a light emitting device, a first engagement portion, a power-connection, and a light-levelling means, but any of the above may be omitted and/or a plurality of any of the features may be provided.

The light emitting device is a device which comprises electronic components capable of emitting at least one beam or wave of light. The emitted light is preferably directional light. The emitted light preferably also has a clear and/or sharp edge or edges when projected onto a mounting surface. This may provide a clear guide or indication of where to position a hole and/or an attachment in the target surface. More preferably, the emitted light is laser light, but any non-laser light may be envisioned. If emitting laser light, the light emitting device may be referred to as a “laser-light emitting device” or simply a “laser”. The light emitted from a laser may be referred to as “laser light”.

The first engagement portion enables engagement with the rail 20. Optionally, the elongate element 16 and/or rail 20 comprises a second engagement portion. The first engagement portion is complementary to the second engagement portion. The first engagement portion and the second engagement portion are preferably slidably engageable, but a non-slidable engagement may be envisioned. This enables each light emitting element 14 to be slidable along the rail 20 and/or elongate element 16. In the shown embodiment, the first engagement portion may be or be a part of the light emitting device such as a surface thereof. The second engagement portion may be or be a part of the rail 20, such as a surface thereof. In the preferred embodiment, the first engagement portion is a surface of the housing of the light emitting device. The first engagement portion is engageable with the inner surface or surfaces defining the cavity 22 and/or if provided, the flange or flanges 26. The inner surface or surfaces of the cavity 22 and/or flanges 26 may be considered to form the second engagement portion.

The power-connection enables the light emitting element 14 to be connectable to a power source. Preferably, the power-connection includes a conductive brush, brush arrangement or brush contact. The conductive brush arrangement provides a connection to the electrically energisable part of the rail 20. Thus, the light emitting element 14 may be powered via the electrically energisable rail 20.

The light-levelling means or mechanism enables each light emitting element and/or the light emitting device thereof to automatically re-orient itself. More preferably, the light-levelling means enables a light emitting element 14 and/or the light emitting device to self-level. This may be advantageous, for instance if the body 12 and/or rail 20 are not level and/or horizontal, the positions indicated by the light emitting elements 14 may not be accurate. The light-levelling means may include a stabiliser, gimbal or gimbal arrangement. An alternative light-levelling means may include a liquid and the light emitting element and/or light emitting device may float at the surface of the liquid. A digital light-levelling means may be a further alternative. The light-levelling means may even cause self-levelling of any or any combination of: one or more elongate elements, and the body, to self-level, instead of or in addition to a light emitting element. Optionally, the light emitting element and/or the light-levelling means may comprise at least one spirit-level. This may enable the user and/or the light-levelling means to check the orientation of the light emitting element.

Optional features of the guide apparatus 10 include a measurement means 28, a pitch-measurement means, a ground-engagement portion 30, a secondary light emitting element 32, a tertiary light emitting element 34, an apparatus-positioning means, a fixture-attachment locator, a locking element 36, and a power source, but any of the above features may be omitted and/or a plurality of any of the features may be provided.

The measurement means, mechanism, position-measurement means element, mechanism or portion 28 in-use enables measurement of the position of a light emitting element 14 relative to the rail 20 which the light emitting element 14 is engaged with. Additionally or alternatively, the measurement means 28 in-use enables measurement of the position of a plurality of elongate elements 16 relative to each other. The measurement means 28 provided in, on, associated with or connected to the body 12, and more preferably with at least one elongate element 16 thereof. Even more preferably, the measurement means 28 is in, on, associated with or connected to at least one rail 20 but this is optional. In the shown embodiment, the measurement means 28 includes at least one, and more preferably a plurality of scales or sets of, preferably numbered, graduations. The one or more scales preferably extend along the longitudinal extent of the at least one elongate element 16 and/or the at least one rail 20.

The pitch-measurement means in-use enables the pitch of the guide apparatus 10 or part thereof to be measured. In other words, the pitch-measurement means enables a user to measure or check how level or horizontal and/or vertical the guide apparatus 10 or any part thereof is. The pitch-measurement means may be referred to as a pitch-measurement element, mechanism, portion, or device, a pitch measurer, a leveller, a levelling means, element, mechanism or portion. In the preferred embodiment, the pitch-measurement means includes at least one spirit-level or bubble level. There may be two or even three spirit-levels. The spirit-levels may extend perpendicularly or normally to each other.

The ground-engagement portion 30 in-use engages with a lower surface. Although the term “ground” is used, it is not intended to be limited solely to a ground surface. Instead, the term “ground” is intended to encompass any surface on which the guide apparatus 10 is positioned, such as a surface of a fixture. The ground-engagement portion 30 may be referred to as a foot. Preferably, the guide apparatus 10 comprises at least one, and as shown, four ground-engagement portions 30. The or each ground-engagement portion 30 is provided on the body 12. More preferably, each ground-engagement portion 30 is provided at or adjacent an end of an elongate element 16 but any ground-engagement portion may be provided away therefrom. In the shown embodiment, two of the elongate elements 16 have two said ground-engagement portions 30 whilst two elongate elements are devoid of any ground-engagement portions 30. However, all or any elongate element 16 may have none, one, or at least two said ground-engagement portions.

Each ground-engagement portion 30 is preferably integrally formed with the body 12. Each ground-engagement portion 30 is preferably a linear projection having a cantilevered end. The projection has a length and a width. The length may be alternatively referred to as a height. The length is preferably comparable to the width but greater or smaller than the width may be options. Short ground-engagement portions may enable the guide apparatus 10 to be more easily storable and/or carriable. The, each or at least one ground-engagement portion 30 may optionally be at least formed of an anti-slip material or comprise one or more anti-slip portions and/or coatings.

The anti-slip portion may comprise a pad, cushioning pad, friction pad, or a coating, any other suitable element, or any combination thereof. The anti-slip portion may comprise plastics, metal, an elastomeric material, a fabric, an adhesive, any other suitable material, or any combination of materials. More preferably, the anti-slip portion may comprise rubber, and/or felt, but any non-rubber and/or non-felt may be envisioned.

The anti-slip portion may have a number of functions. A first function may be to increase the friction between the ground-engagement portion 30 and the ground. The anti-slip portion may thereby prevent or inhibit displacement or movement of the guide apparatus 10 relative to the ground. A second function may be to prevent or inhibit damage to the ground. A third function may be to prevent, inhibit or dampen noise caused by operating and/or moving the guide apparatus 10. For example, this may be advantageous in a flat, to reduce the noise reaching a room below. A fourth function may be to reduce the risk of injury by providing a barrier between a user and a sharp edge of the ground-engagement portion 30, by way of example only.

Although numbered incrementally, all the above functions may be of equal importance. Any of the functions may be omitted and/or any of the above functions may be of greater importance than another of the above functions.

Furthermore, although the ground-engagement portion, the pivots and the locking element are preferably distinct features, it may easily be envisioned that any pivots and/or locking element may function as the ground-engagement portion.

The secondary light emitting element, dataline laser, or secondary light emitter 32 in-use projects or can be configured to project light at a right angle relative to a said light emitting element 14. In other words, the secondary light emitter 32 may emit light at least partly in or parallel with the prevailing plane of the body 12. More preferably, the light is laser light, but non-laser light is in option. The secondary light emitter 32 is similar or the same as an above-described light emitting element 14. Detailed description of the common features may be omitted for brevity.

The secondary light emitter 32 may be movable but preferably is non-movable or fixed relative to the body 12. In the shown embodiment, there are four secondary light emitters 32, but any number, including none, one, two, three or more than four may be provided. The, each or any secondary light emitter 32 may be received in, on or be associated with the body 12 and/or with a said light emitting element 14. More preferably, the, each or any secondary light emitter 32 is provided at, on, at least partly in, or adjacent to any or any combination of: a said elongate element 16, a said rail 20, and a said ground-engagement portion 30. The, each or any secondary light emitter 32 may be provided at or adjacent an end of an elongate element but away therefrom may be an option. Preferably, each secondary light emitter 32 is provided on a said ground-engagement portion 30. Each or any subset of secondary light emitters 32 may extend colinearly and/or parallel to at least one further said secondary light emitter 32.

The secondary light emitter 32 may have several advantages. A first advantage is that the user can align a measuring device, such as a tape measure or range finder with the beam of light emitted by the secondary light emitter 32 and ensure or increase the likelihood of the tape measure or range finder being straight. In turn, the distance between the guide apparatus 10 and a further surface, such as a wall, floor or ceiling is more accurately measured. A second advantage is that the user can temporarily leave the guide apparatus in position to measure the angle between the further surface, such as a wall, and the beam of emitted light. If the beam is perpendicular to both the further surface and a side of the guide apparatus 10, the side of the guide apparatus 10 is likely to be parallel with the further surface. A third advantage is that the user can measure the angle between the beam of emitted light and either or both horizontal and vertical directions. This enables the user to check the pitch of the guide apparatus 10. A fourth advantage is that the secondary light emitter 32 can project the position of one or more light emitting elements 14 onto the further surface. The user can then determine or measure the position and/or distance of the light emitting element 14 along the further surface, such as from a corner, edge between two walls or other reference point. In other words, the secondary light emitters 32 enable a user to ensure the squareness of the position of the product.

The tertiary light emitting element or tertiary light emitter 34 in-use projects or can be configured to project light in a different direction relative to both a said light emitting element 14 and the secondary light emitter 32. Said direction is preferably orthogonal, but non-orthogonal is an option. The tertiary light emitter 34 is similar to the secondary light emitter 32. Detailed description of the common features and functions is omitted for brevity. In other words, the tertiary light emitter 34 may emit light at least partly in or parallel with the prevailing plane of the body 12. More preferably, the light is laser light, but non-laser light is in option. The tertiary light emitter 34 enables a user to align the tape measure or range finder in a different direction, for example to measure the distance to a second wall. In the shown embodiment, there are four tertiary light emitters 34, but any number may be provided. Each or any subset of tertiary light emitters 34 may extend colinearly and/or parallel to at least one further said secondary light emitter 34.

Preferably, the secondary light emitter 32 and/or tertiary light emitter 34 are provided at or aligned with the relevant elongate element 16 upon which the light emitting element or elements 14 are received in or on. In other words, the position of a light emitting element or element 14 may be projected onto one or more further surfaces.

An apparatus-positioning means, mechanism or guide in-use is an aid or guide to further help position the guide apparatus 10. In particular, the apparatus-positioning means enables a user to measure the distance of the guide apparatus 10 relative to a reference point, an item or surface, such as a wall. The apparatus-positioning means may include any or any combination of: a tape measure, a range finder, or any other suitable device or mechanism which can measure a distance. Optionally, the apparatus-positioning means may comprise a user-interface which a user can interact with. The user-interface can provide an indication of a distance. The indication may be auditory, via a microphone for instance, and/or visually, via a screen for example. The screen may be an LCD display. In a modified embodiment, the user may specify via the user-interface a desired distance. The apparatus-positioning means may then monitor the actual distance and indicate to the user when the desired distance from the guide apparatus 10 and the item or surface is detected.

The fixture-attachment locator or indicator enables a user to align a light emitting element 14 more easily with an attachment or attachment point on a fixture to be mounted onto a target surface. The fixture-attachment locator may include any element, portion or device which indicates the location of a light emitting element 14 relative to the attachment or fixation point thereof, or vice-versa. The fixture-attachment locator may be any of: integrally formed with, connected to, connectable to, in, on, or associated with a light emitting element 14. More preferably, the fixture-attachment locator may be provided on and/or extend from the light emitting element 14. The fixture-attachment locator may extend in or be oriented at least in part towards a direction opposite to the direction of the light emitted by the light emitting device. The fixture-attachment locator may include any of: a pin, a needle, a rod, a pole, a quaternary light emitter, a string, a chain, a plumb line, any other suitable element, or any combination thereof.

If a quaternary light emitter if provided, the quaternary light emitter may be similar to a light emitting element 14. Detailed description of the common features is omitted for brevity. Light emitted may be laser light and/or non-laser light.

The direction of extension of the fixture-attachment locator may optionally be parallel or colinear with the direction of the light emitted by the light emitting element 14. In other words, the fixture-attachment locator extends preferably perpendicularly to the prevailing plane of the body 12, but this is optional. Preferably, the fixture-attachment locator extends in the opposite direction to the light of the light emitting element 14. The advantage of this feature will be hereinafter explained. The light emitted and/or the fixture-attachment locator may extend through a said opening 24.

The locking element 36 may also be referred to as a locking mechanism, means, or device, or lock. The locking element 36 locks the position of at least one light emitting element 14 relative to the body 12 and/or the relative position of two or more elongate elements 16 relative to each other. The shape and/or configuration of the locking element 36 may determine the number of possible positions and/or the relative position.

In other words, the locked position of a light emitting element 14 may be selectable from a continuous range of positions, from a set of discrete positions or there may be only one position, depending on the locking element 36.

If pivotable, the elongate elements 16 may be lockable at an angle relative to each other. The angle may be selectable from a continuous range of angles, from a subset of angles, or there may be only one angle at which elongate elements 16 may be locked, depending on the locking element 36. In the shown embodiment, the locking element 36 includes at least one, and preferably as shown, four clip elements 38.

Each clip element 38, also referred to as a clip, is preferably separably engageable with the body 12, but non-separably engageable may be an option. Each clip element 38 in the preferred embodiment is received at or adjacent where at least two elongate elements 16 connect or meet. In the shown embodiment, each pair of elongate elements 16 forms an internal corner 40. Whilst there are four internal corners 40 shown, it is understood that there may be fewer or more internal corners, depending on the shape of the body. At least one said clip element 38 is receivable in at least one internal corner 40. As shown, each clip element 38 is received in each internal corner 40. The clip element 38 may comprise a wedge. Preferably, each clip element 38 includes a right-angle. This enables the body 12 to be a square or rectangle by maintaining the elongate elements 16 perpendicular to each other.

The power source in-use powers at least one said light emitting element 14, whether directly and/or indirectly. The power source provides power, preferably electrical power, to the, each, or all rails 20 in the preferred embodiment, but any other part of the guide apparatus may additionally or instead be powered. The power source preferably includes a battery, but any other source of power may be envisioned, such as the electrical mains. At least further power source may be provided, as a back-up. Preferably one or more power sources may be received or receivable on, or within the body 12 and/or one or more elongate elements 16, or associated therewith. The battery may have a battery housing. The battery may be a 12-volt battery but any non-12-volt battery may be used. The battery is preferably rechargeable.

In-use, the user may need to assemble the guide apparatus 10 prior to use, if not already assembled. The guide apparatus 10 may be provided as a kit of parts. To assemble the guide apparatus 10, the user carries out the following steps, not necessarily in the following order. At least one light emitting element 14 is engaged with an elongate element 16 and/or the rail 20. Preferably, two elongate elements 16 are engaged with two light emitting elements 14 and two elongate elements 16 are devoid of any light emitting elements 14. However, all or any number of elongate elements may be engaged with at least one light emitting element. Any number of elongate elements may be devoid of a light emitting element. There are preferably at least as many light emitting elements 14 as there are attachment points on the fixture, although fewer may be an option.

In the shown embodiment, each light emitting element is received at least in part within a said rail 20. A light emitting element 14 is preferably inserted via an open end of the rail 20, if any is provided, and more preferably within the cavity 22. In an alternative method of engaging a light emitting element and the body, the light emitting element may be formed of at least two connectable parts. The connectable parts may extend at least in part through the cavity and connect with each other to form a unitary light emitting element.

Each light emitting element 14 is preferably translatable along the longitudinal extent of the rail 20. The shape and/or configuration of the rail 20 in the preferred embodiment prevents or inhibits the light emitting elements 14 from being laterally removable once inserted into the rail 20. This prevents or inhibits accidental removal of the light emitting elements 14 from the guide apparatus 10.

The rails 20 are preferably an integral part of the elongate elements 16 but if not, the rails 20 may be engaged with the, each or any number of elongate elements 16.

Before, during or, preferably after engaging the light emitting elements 14 with the rails 20, the body 12 is formed by connecting the elongate elements 16 together. More preferably, each elongate elements 16 is connected at or adjacent an end thereof to a further elongate element 16. All elongate elements 16 may be connected to form the body 12 in a first configuration, also referred to as a starting configuration or initial condition.

Preferably, in the starting configuration, the body 12 is a polygon and/or the elongate elements 16 form a polygon. The polygon in the preferred embodiment is a quadrilateral, and more preferably a parallelogram as shown in FIG. 3, but any alternative polygon or even a non-polygon may be envisioned. The guide apparatus 10 shown in FIG. 3 is not to scale, at least relative to the fixture 42 to be mounted.

Connecting two elongate elements 16 together may optionally temporarily close, seal, block, prevent or at least inhibit removal of a light emitting element 14 via the open end of the rail 20. A cap may optionally be provided to close the or each open end.

To disassemble the guide apparatus 10, the above steps are done in reverse.

The body 12 and/or elongate elements 16 are preferably deformable or reconfigurable. This enables the support body 12 to be dimensionally-adjustable. In other words, the support body 12 is actuatable, moveable, reconfigurable, or deformable from the starting configuration into a second configuration, also referred to as an end configuration or use condition. FIG. 4 shows the guide apparatus 10 in a use condition.

Preferably, the body 12 and/or elongate elements 16 are deformable by virtue of being pivotably connected together, but elongate elements may additionally or alternatively be translatable relative to each other. The elongate elements may be neither translatable nor pivotable, but instead may be engageable with each other at selectable positions along their extents. In the present embodiment, the body 12 is square or rectangular when in the use condition.

Optionally, the body 12 and/or elongate elements 16 may be actuated, deformed or moved into a third condition, also referred to as a storage condition or configuration, or a compact configuration, not shown. In the preferred embodiment, the elongate elements 16 may be collapsed or concertinaed together. In the third condition, the guide apparatus 10 is not able to be used to identify mounting points on a mounting surface. It may easily be envisioned that the guide apparatus in the third condition may be able to be used to identify mounting points on a mounting surface but is not used to do so. In the third configuration, the guide apparatus 10 is easily storable and/or transportable, preferably by virtue of being compact, even when assembled or partly assembled. The guide apparatus 10 may optionally be stored in a carriable case. The starting condition and the third condition may optionally be one and the same, or they may be different to each other.

The body 12 and/or elongate elements 16 are selectably deformable, actuatable, reconfigurable, or movable from any one of the first, second or third conditions into any further one of the first, second or third conditions. The body 12 and/or elongate elements 16 may even be deformed, actuated or moved between two first conditions, or between two second condition, or between two third conditions.

Once the guide apparatus 10 is assembled and in a first condition, the user can use the guide apparatus 10 to more easily and/or more quickly identify an outline or position of an opening and/or one or more mounting points of a fixture on a mounting surface.

In FIGS. 5 and 6, the fixture 42 is shown to be an air-conditioning unit or part thereof. In FIG. 5, parts of two air-conditioning unit are shown. FIG. 6 shows a single air-conditioning unit in top plan view, with an additional front plate 44 and a conduit 46 connected to the main body 48 of the fixture 42. The unit is or is substantially square in plan view and rectangular in side view, but a non-square shape in plan view and/or nonrectangular shape in side view may be options. At least one, and preferably four attachment points 50 are provided on the shown fixture 42. The corners 52 of the air-conditioning unit are chamfered or generally chamfered in the present embodiment, but non-chamfered may be an option. A rounded corner may be an option. Each attachment point 50 is provided here at each chamfered corner 52 but away therefrom is an option. Each attachment point 50 comprises a bore, recess, or hookable portion. In the shown embodiment, each attachment point 50 is a pitching hole. At least one and preferably four attachments or fasteners 54, which are here tethers or cables, are provided. The or each attachment 54 is engageable at one or adjacent one end with the attachment points 50 of the fixture 42. The tethers or cables are engageable at the other end with the mounting surface 56, which is a ceiling here. The locations where the attachments 54 engage with the mounting surface 56 are referred to as “mounting points 58”. The attachments points 50 are preferably non-overlapping, non-overlaid or non-colinear with each other but overlapping or partially overlapping may be options. Similarly, the mounting points 58 are preferably non-overlapping, non-overlaid or non-colinear with each other, but overlapping or partially overlapping may be options.

Furthermore, the outline of the body 12 and four light emitting elements 14 of the fixture-installation guide apparatus 10 have been overlaid on top of the fixture 42 in dashed lines.

The user positions or repositions the light emitting elements 14 relative to each other so that the two-dimensional spatial distribution of the light emitting elements 14 matches or corresponds to the spatial distribution of the attachment points 50 of the fixture 42 to be mounted onto the mounting surface. The apparatus 10 may additionally or alternatively be used to indicate an outline and/or a position of an opening in the target surface 56.

A first method of matching the spatial distribution of light emitting elements 14 with that of the attachment points 50 is by using the fixture 42.

The user starts by actuating the guide apparatus 10 from the starting condition to the use condition. Altering the position of the light emitting elements 14 may be done via moving at least one light emitting element 14 along the rail 20 and/or via moving at least one elongate element 16 relative to another.

For example, the user may pivot elongate elements 16 relative to each other. In the shown embodiment, the quadrilateral may be transformed into a rectangle or square. The shape and/or size of the guide apparatus 10 is thereby adjusted in two dimensions to fit the fixture. Adjustment in three dimensions may be desirable to accommodate a fixture having a projection, shape or configuration which may prevent or inhibit the guide apparatus 10 from being engaged with the fixture.

Optionally, once the body 12 is in the use condition, the user may temporarily prevent or inhibit the body 12 from being reconfigured into a different shape using the or at least one locking element 36. In the shown embodiment, the user inserts a clip element 38 in each of the internal corners 40.

The user lays and/or affixes the guide apparatus 10 on and/or to the fixture 42 at any time.

The user aligns each light emitting element 14 with an attachment point 50 of the fixture 42. In other words, each attachment point 50 is overlaid by and/or coaxial with a light emitting element 14. This is illustrated in FIG. 6 where the dashed outline of each of the four light emitting elements 14 is aligned with a said attachment point 50.

If a fixture-attachment locator is provided, the fixture-attachment locator may facilitate the alignment. For example, if the fixture-attachment locator is a quaternary light emitter, the user would move the light emitting element 14 until the light emitted by the quaternary light emitter is projected onto the attachment point 50. No measuring of distances between light emitting elements 14 and/or between elongate elements 16 is required using this method. However, the measurement means 28 can be used to check distances.

Optionally, the position of one or more light emitting elements 14 can be temporarily locked in position by the locking element 36. This enables the light emitting elements 14 to be stabilised, particularly if the guide apparatus 10 is subsequently moved.

The guide apparatus 10 may already be in the appropriate position relative to the environment and/or mounting surface. If so, the guide apparatus 10 may remain on the fixture 42 until the guide apparatus 10 is no longer needed. The ground-engagement portions 30 engage with the surface of the fixture 42 in this case.

If the guide apparatus 10 is not already in position, the user can move the guide apparatus 10 to the appropriate position. If provided, any or any combination of: the secondary light emitting element 32, the tertiary light emitting element 34, and the apparatus-positioning means or positioner may be used to help position and orient the guide apparatus 10. The user may check the squareness of the guide apparatus 10 or at least of a mounting point. In other words, the guide apparatus 10 may project two perpendicular lines of light towards two perpendicular walls. The walls and the two lines or light preferably form a square. The light emitting element 14 may project a third beam perpendicularly to both lines of light. The guide apparatus 10 is laid on the ground or surface 60 below and/or facing the mounting surface to project light thereonto. This is shown in FIG. 7, although all the light-emitting elements 14,32,34 are omitted for clarity in FIG. 7. The guide apparatus 10 may be shown upside down in FIG. 7. The ground-engagement portion 30, if provided, engages with the ground.

The light emitting elements 14 can be electrically energised to emit light at any step of the process. In the preferred embodiment, the light emitting elements 14 are powered to emit light via contacting an electrically energised portion of the rail 20. If a said light emitting element 14 is provided with a conductive brush, the brush contacts the contact element. The opposite arrangement may easily be envisioned, whereby a light emitting element may have a contact element and the rail may have a conductive brush.

Once the plurality of light emitting elements 14 are selectably positioned on the dimensionally-adjustable support body 12 so that their distribution matches the distribution of the attachment points 50 and the guide apparatus 10 is in the appropriate location, the light emitting elements 14 project light onto the mounting surface. Light is projected preferably normal or perpendicular to the prevailing or defining plane of the body 12. The projected light indicates the location of the mounting points, and the relative distribution of the mounting points matches that of the attachment points 50.

The user can mark each mounting point 58 on the mounting surface. Alternatively or additionally, the user can directly engage the attachments 54 with the mounting surface and/or drill holes to receive the attachments 54. As the guide apparatus 10 indicates the correct location of all mounting points 58 simultaneously, there is no need to measure the distances between mounting points 58 or between a mounting point 58 and another surface, such as a wall. The user does not need to descend and ascend a ladder to check measurements between marking each mounting point 58 and/or engaging an attachment 54 with the mounting surface.

Once the mounting positions 58 are marked and/or the attachments 54 are engaged with the mounting surface 56, the fixture 42 is moved towards the mounting surface 56. This is illustrated as Arrow A in FIG. 8. The fixture 42 is engaged with the mounting surface 56 via the attachments 54 which are connected to the attachment points 50.

All the positioning, and if required, measuring, can be done from the ground surface. Installing a fixture is easier and the speed of installation is increased.

After use, the guide apparatus 10 can be reconfigured into the third condition for storage.

A second method of matching the spatial distribution of light emitting elements 14 with that of the attachment points 50 is provided if not using the fixture, for instance, if the fixture is not available. In this case, the measurement means 28 may enable the light emitting elements 14 to be accurately positioned. For instance, if the user knows the distances between all attachment points 50 of the fixture, the user can use the measurement means 28, which is preferably a scale, to measure the distances between the light emitting elements 14, and move any light emitting elements 14, as required. The user may also use the measurement means 28 to measure the relative positions of and/or specific angles between elongate elements 16. Once the spatial distribution of the light emitting elements 14 matches that of the attachment points 50 of the fixture, the same steps as above apply. Detailed description of the common steps is omitted for brevity.

Referring now to FIG. 9 there is shown a second embodiment of a guide apparatus indicated generally at 110. Features of the second embodiment which are similar to the first embodiment have similar reference numerals with the prefix “1” added. The second embodiment of the guide apparatus 110 is similar to the first embodiment of the guide apparatus 10, having similar support body 112, light emitting element 114, light-engagement means 162, ground-engagement portion, pitch-measurement means, and power source 164. Optionally, the apparatus 110 may comprise a secondary light emitting element 132, a tertiary light emitting element 134, an apparatus-positioning means, quaternary light emitter, and a locking element. Any of the above may be omitted and/or a plurality of any of the above may be provided. Detailed description of the common features and caveats is omitted for brevity. Detailed description of the differences is provided hereinafter. Additionally, the apparatus 110 further comprises an actuator 166, control means 168, a user-interface 170, and location-detection means 172.

Preferably, the second embodiment of the apparatus 110 does not comprise any elongate elements nor any rails. Consequently, no measurement means, enabling the measurement of the position of a light emitting element relative to the rail, are provided. Furthermore, no fixture-attachment locator is provided in the second embodiment of the apparatus 110. However, any or all of the above omitted features may be provided.

In the second embodiment, the support body 112 is preferably compact. The support body 112 includes a housing 174a and a movable support element 174b, but either feature may be omitted and/or a plurality of either may be provided.

The housing 174a in-use houses and/or providing a protective casing to all or a subset of features of the apparatus 110. The housing 174a is preferably polygonal in side, front and plan views but non polygonal but may be an option.

The movable support element 174b, also referred to as a movable support, in-use provides a support for at least one of, and preferably all the light emitting elements 114. Furthermore, the movable support element 174b is preferably movable. More preferably, the movable support element 174b is pivotable or rotatable about an axis 186 but may additionally or alternatively may be translatable relative to the housing 174a. The movable support element 174b is connected or connectable to the housing 174a. The movable support element 174b may be internal to the housing 174a, but preferably as shown, is external thereto. The movable support element 174b preferably includes a platform or platform element, as shown. The platform is preferably a square or rectangular platform but could be any alternative shape, such as circular, or a cross, by way of examples only. The exact shape of the housing 174a and/or movable support 174b are not critical. The one or more light emitting elements 112 of the second embodiment are similar in function and purpose to those of the first embodiment. Detailed description of the common features is omitted for brevity. Preferably, the or each light emitting element 114 includes at least one light emitting device 176 and the or a said power source 164 or connection thereto, but any of the above may be omitted and/or a plurality of any of the above may be provided. Preferably, there is no first engagement portion as there is no rail. There is also preferably no light-levelling means. The light emitting device 176 in-use emits a light beam, and more preferably a laser light beam. In the preferred embodiment, one or more light emitting devices 176 each has a light emitting aperture 178 that is elongate along an aperture axis 180. The light projected from the light emitting device 176 onto the target surface is shaped by the light emitting aperture 178 into an elongate shape, such as a line. In the case of a line, the line is parallel to the aperture axis 180. The power supply or source 164 is preferably a battery but any alternative, such as electrical mains. The same power supply 164 may be shared between a plurality of light emitting devices 176 and/or a plurality of light emitting elements 114. Preferably however, each light emitting element 114 comprises a distinct power supply 164.

Light-engagement means or portion 162, as per the first embodiment, in-use engages or supports, directly or indirectly, the at least one light emitting element 114. Optionally, the light-engagement means 162 may further support or engage the or a said actuator 166. The light-engagement means 162 connects the at least one light emitting element 114 to the support body 112, and if provided, more preferably to the movable support element 174b thereof. The light-engagement means 162 may include a bracket, flange or extension portion 182 as shown. The extension portion 182 here extends, preferably at least in part upwards, from the housing 174a and/or movable support element 174b.

The ground-engagement portion 130 may be a bottom wall of the housing 174a in the second embodiment, but optionally, one or more linear projections, wheels, and/or anti-slip portions may be envisioned, as per the first embodiment.

The pitch-measurement means may optionally be provided as any of: a spirit level, a gyroscopic sensor, and any other means of measuring a deviation from horizontal of the apparatus. The gyroscopic sensor may be communicable with the user-interface 170 for providing feedback to the user. The user may manually adjust the level. Additionally or alternatively, the gyroscopic sensor may provide feedback to the control means 168 which may then automatically level the apparatus 110 or any part thereof.

The actuator 166 in-use may be activated to move one or more light emitting elements 114 and/or one at least one light emitting device 176 thereof. The actuator 166 is associated with the support body 112. Preferably, there are a plurality of actuators 166. More preferably, at least one, and preferably each light emitting element 114 or light emitting device 176 is associated with at least one actuator 166. One actuator 166 will be described in more depth hereinafter but it is understood that the description and caveats apply for each actuator 166. The actuator 166 in-use selectively pivots or rotates a light emitting device 176 in at least one direction. Optionally, the actuator 166 may selectively act as a locking element for locking the position of at least one light emitting element 114 relative to the body 112. Translation of a light emitting device by an actuator 166 may additionally or alternatively be an option, although not provided in the second embodiment. The actuator 166 preferably includes an actuator portion 184a and drive means 184b but either feature may be omitted and/or a plurality of either feature may be provided. The actuator portion 184a has an edge 188. The edge 188 is more preferably arcuate. Furthermore, the actuator portion 184a preferably includes a circular sector. The actuator portion 184a is pivotable around a pivot axis 186. The drive means 184b, or driver, in-use drives the motion of the actuator portion 184a. The drive means 184b in the preferred embodiment includes a wheel.

The wheel is engageable or engaged, abutted or abuttable against the edge 188. Optionally, the wheel is a cogged or toothed wheel having teeth. The edge 188 may optionally have complementary teeth. However, friction may be sufficient, without requiring any teeth. At least one light emitting device 176 is mounted or mountable to the actuator 166, and more preferably to the actuator portion 184a. Any mounting means or mount may be envisioned, but as shown a mounting clip or holder 190 is preferably provided. The light emitting device 176 may optionally be removably engageable with the mounting means. The pivot axis 186 is preferably parallel with or colinear with the aperture axis 180, but this is optional.

Optionally a further actuator, not shown, may be provided, associated with the movable support element 174b. More preferably, the further actuator may translate and/or rotate the movable support element 174b. The further actuator 166 preferably rotates the movable support element 174b around an axis 186 which is preferably normal to the or each pivot-axis 186.

The control means 168, also referred to as a controller, in-use at least one, and preferably a plurality of functions. In no particular order, the first function is to control the or each actuator 166. More preferably, the control means 168 may provide a command to the actuator 166, so as to position a specific light emitting device 176 in a specific orientation and/or position relative to the body 112. An example of a command may be to rotate by 5° clockwise. A second function may be to estimate or calculate a location and/or height of the apparatus 110 relative to any or any combination of: the target surface, the ground surface, a further wall, or a plurality of walls. A third function of the control means 168 may be to determine the required orientation and/or position of the, each, or a said light emitting device 176 as a function of the apparatus to be mounted and/or as a function of the location and/or height of the apparatus 110. A fourth function may be to process an input and/or provide an output. The input may be from a user, a sensor or any other part of the apparatus 110. Similarly, the output may be to the user, a sensor, or any other part of the apparatus 110. The control means 168 preferably includes a processing element 192a, a calculating element 192b, a memory unit 192c, at least one communication channel 192d, but any of the above may be omitted and/or a plurality of any of the above may be provided.

The processing element 192a may be a processor or circuit, which in use integrated inputs and provides outputs. The calculating element 192b, also referred to as a calculating circuit, in-use may have any of the following functions. A first function may be to calculate the location and/or height of the apparatus 110. The calculations may be based on any or any combination of: data stored in the memory unit 192c, data received from the or any said sensor, and data received from the user via the user-interface 170. A second function may be to calculate the required orientation of the or each light-emitting device 176 so that light is projected onto the correct location on the target surface 56 after accounting for the orientation of and/or the distance between the light-emitting device 176 and the target surface 56. If the light emitting device 176 is not in the correct orientation and/or position, a third function of the calculating element 192b may be to calculate the required movement to be imparted by the actuator 166 to reposition the light-emitting device 176. The calculating element 192b outputs to the processing element 192a data relating to the calculated orientation and/or position of the or each light emitting device 176 and optionally data relating to required movements of light emitting devices 176.

The communication channel 192d enables communication between different components of the control means 168 and/or between the control means 168 and a further component of the apparatus 110. The communication channel 192d may be wireless or wired, such as a circuit wire. The user-interface 170 in-use enables a user to provide an input to the apparatus 110 and/or provide an output to the user. The user-interface 170 preferably includes a screen as shown, but any alternative or additional portion or element capable of receiving an input and/or providing an output may be provided. Examples of such elements may include a button, a keypad, a toggle, a dial, an emitter, a receiver, a transceiver, a microphone, a speaker, a data-input port, a data-output port, a USB port, by way of examples only. The screen may be an LCD display, such as a 20×4 LCD screen. The screen may optionally be tactile, such as a Thin Film Transistor or TFT Liquid crystal display screen.

The location-detection means or location-detector 172 in-use enables the apparatus 110 to at least detect its position relative to a wall and/or target surface. Optionally, the location-detection means 172 may enable the apparatus 110 to automatically compensate for any deviations from a required position. The location-detection means 172 differs from the apparatus-positioning means of the first embodiment in that the apparatus-positioning means enables a user to detect and reposition the apparatus. The location-detection means 172 on the other hand does not require the user to take any action. The location-detection means 172 preferably includes a distance-measurement device 194a and a height-measurement device 194b, but either may be omitted and/or a plurality may be provided.

The distance-measurement device 194a and the height-measurement device 194b in-use measure a distance to a wall and a height, respectively. The height and distance are preferably relative height and relative distance, such as relative to the target surface and/or relative to a further surface, but absolute height, such as altitude and/or absolute position, such as GPS coordinates, may be options. The distance-measurement device 194a and/or the height-measurement device 194b are preferably mounted or mountable to the movable support element 174b but this is optional. At least one, and preferably each device includes a distance sensor 196, such as a range finder. The distance-measurement device 194a preferably comprises a plurality of distance sensors. The distance sensor of the height-measurement device 194b is preferably perpendicular to at least one, and preferably all the distance sensors of the distance-measurement device 194a.

Preferably, at least two distance sensors 196 of the distance-measurement device 194a, referred to as paired distance sensors in the case of two sensors, may have the same orientation as each other. Each distance sensor 196 has a distance-finding axis 196a along which the distance is measured. The distance-finding axes 196a are preferably parallel with each other. There may be a plurality of pairs of distance sensors 196, each pair being oriented toward a different surface. The purpose of the paired distance sensors 196 will be explained in more depth hereinafter.

In use, the user obtains an apparatus 110. The apparatus 110 may be used to project the position of an opening, such as an opening or hole for a door, a window, a skylight, ducting, a cable, such as an electrical cable, a cable tray, by way of examples only. The apparatus 110 may indicate at least the location of the corner of the opening. Optionally, the apparatus 110 may additionally illustrate the outline of the opening. Additionally or alternatively, the user may obtain a fixture to be mounted to a target surface, such as a door, a window, or an air-conditioning unit by way of examples. If not already stored in the memory unit 192c, the user may provide to the apparatus 110 the relative arrangement of the attachment points of the fixture. The user may also input the desired position on the target surface of the fixture and/or opening. The user can input this data via the user-interface 170, such as manually via the screen and/or via a personal communications device. The user may then position the apparatus 110 in approximately the correct location. However, the user does not need to measure the exact location of the apparatus 110. Unlike the first embodiment, the apparatus 110 is able to determine its location and height automatically via the location-detection means 172, sparing the user effort and saving time. In particular, the range finders may measure the distance between the apparatus 110 and at least one of, and a combination of: the target surface, a first wall, and a second wall. The paired distance sensors 196 measure the distance to a common surface as shown in FIG. 11. If the distance measured by one of the paired sensors 196 differs from the distance measured by the other, the calculating element 192b can determine that the distance sensors 196 are not perpendicular and/or equidistant to the common surface. The calculating element or calculator 192b may optionally be capable of calculating the angle formed by the orientation of one of the distance sensor and the surface.

If a plurality of paired sensors is provided, each pair may measure the distance to a distinct surface. Alternatively, the or a said pair of distance sensors may be moved so as to be directed towards a further common surface. As illustrated in FIG. 11, the movable support element or movable support 174b is moved, for example by rotating the movable support element 174b around its pivot axis 186. The paired distance sensors 196 once again measure the distance to the further common surface and the calculating element 192b calculating whether the measurements differ. These steps may be repeated as required.

Where a difference in distance measurements from the paired is detected, the control means 168 may rectify the orientation of the distance sensors 196 and/or the light-emitting device or devices 176 if required, for example by controlling at least one actuator 166 and/or the further actuator 166 to rotate the movable support element 174b. It may be beneficial for example for two edges of the platform to be parallel with two walls. This may enable or facilitate the alignment of projected points and thus of the fixture 42 on the target surface 56 relative to the walls. In other words, the apparatus 110 may correct its squareness relative to two walls.

Optionally, if provided, the secondary light emitter 132 and/or the tertiary light emitter 134 may project one or more lines on the surfaces to enable the user to visually check the alignment of the apparatus 110, and optionally make any necessary adjustments if required. This step may be referred to as a calibration mode or calibration step.

Once the location and height of the apparatus 110 have been calculated, the control means 168 controls the actuators 166 and/or the further actuator 166 to position or reposition the light-emitting devices 176. This may involve rotating the wheel of an actuator 166, as illustrated by comparing FIGS. 12a and 12b. In turn the actuator portion 184a may be pivoted around its pivot axis 186. The light-emitting device 176 is pivoted, tilted or angled relative to vertical by the actuator 166, as shown in FIG. 12b. The light emitted translates along the target surface, as shown by comparing FIGS. 13a and 13b. The result is that the position of the opening and/or of the fixture mounting points 58 indicated by the projected light are accurately positioned on the target surface 56, after taking into account the distance between the apparatus 110 and the target surface 56, as well as the location of the apparatus 110. The target surface 56 is preferably a ceiling but may be a wall or even a floor. In the second embodiment, each light-emitting device 176 emits light which preferably forms a line on the target surface 56, as shown in FIGS. 13a and 13b. The position of a mounting point 58 is indicated by the intersection of two lines projected by two light-emitting devices 176. As there are preferably four light-emitting devices 176, four lines intersecting pairwise are projected onto the target surface. The four lines may optionally form a square or rectangle. The intersections indicate four distinct, non-overlapping positions of four mounting points 58 and/or four corners of the opening to be made in the target surface 56. Any number light emitting devices may be envisioned however, to project a different number of mounting positions and/or corners. Optionally, the lines may show an outline of the fixture and/or the edges of the opening to be cut in the target surface. The apparatus 110 may even be used to indicate a plurality of openings and/or mounting points for a plurality of fixtures, sequentially and/or simultaneously. Thus, when setting out, the positions of any or all of: electrical tray work, ductwork, bracketry, containment, pipework, doors, windows, air-conditioning units, and other fixtures can be indicated by the apparatus 110.

A potential issue with projecting light non-vertically may be that the light beam may be prevented from reaching the target surface, for example by piece of furniture, such as a ladder or user platform. Furthermore, depending on the distance between the apparatus 110 and the target surface, the light beam emitted by the light emitting element 114 may become diffuse over the distance such that the projection onto the target surface no longer has a sharp outline. Both issues may be addressed by positioning the apparatus 110 closer to the target surface, such as on a user platform or ladder where the target surface is a ceiling. The apparatus 110 may simply calculate the new distance to the target surface and compensate accordingly, as described previously.

Referring now to FIGS. 14, 15a and 15b, there is shown a third embodiment of a guide apparatus 210. The third embodiment is similar to the second embodiment, having same or similar body 212, one or more light emitting elements 214, light emitting devices 276, actuators 266, control means, location-detection means, distance-measurement device 294a and a height-measurement device 294b. Detailed description of the common features and caveats is omitted for brevity. Features of the third embodiment which are similar or the same as those of the second embodiment have similar reference numerals, with the prefix “2” replacing the previous prefix. Differences are described hereinafter. Preferably the actuator 266 of each light emitting device includes an actuator portion 284a. Each actuator portion 284a is rotatable along at least two pivot axes 286 which are non-parallel and non-colinear, as shown by Arrows B and C in FIGS. 15a and 15b. The actuator portion 284a is preferably spherical, substantially spherical, or part spherical as shown. Preferably, no circular sector is provided. A movable support element may optionally be provided. The paired distance sensors are omitted but could easily be provided. Furthermore, the light emitted from each light emitting device 276 preferably forms a circle on the target surface rather than a line, although this alternative may be envisioned. The apparatus 210 may optionally include a secondary outer casing 298. The outer casing 298 may include a resiliently deformable material, such as TPE rubber. The outer casing 298 may be over-moulded onto the body 212. The outer casing may in-use absorb impacts. The outer casing 298 may additionally provide aesthetic customisability. The ground-engagement portion may optionally include part of the outer casing 298. If including rubber, the outer casing 298 may additionally function as an anti-slip portion.

The uses of the third embodiment are similar or the same as the second embodiment. Detailed description of the common steps and caveats is omitted for brevity.

In the first embodiment, the body comprises four elongate elements, connected to form a polygon, and more preferably a quadrilateral, and most preferably a parallelogram reconfigurable into a rectangle or vice-versa in plan view. However, the body in any embodiment may have any alternative shape in plan view and/or cross-section. For example, the shape of the body may be any of: curved, part curved, non-curved, linear, part linear, non-linear, a broken line, any polygon, whether regular or irregular, having one or more chamfered and/or rounded corners, a triangle, a quadrilateral, such as a square, a rectangle, a trapezium, a trapezoid, a pentagon, a hexagon, a heptagon, an octagon, or any other polygon, or a cross. The shape may be an ellipse, a circle, part circular, an oval, or any abstract shape. The elongate elements may be at least part curved. For example, an elongate element may be or include an arc of a circle. Any number of elongate elements may be used to form any shape. Two or more elongate elements may be colinear or non colinear with each other. The shape of the body may match or be reconfigurable so as to match the shape of the fixture.

Whilst all pivot points are preferably fixed, in an alternative embodiment a said elongate element may further comprise a pivot-point guide channel along which one or more said pivot points may be slidable. Any or any combination of elongate elements may have such a pivot-point guide channel. In a further alternative embodiment, at least one elongate element may be non-pivotably connected to another elongate element. Instead, two or more elongate elements may be connectable with each other with each other at one position or at a range of positions. The range of positions may be continuous or discontinuous. For example, an elongate element may be engageable with a further said elongate element along the longitudinal extent of either elongate element. The elongate element may be engageable with the further said elongate element via a clippable arrangement, a fastener, complementary female and male portions, or any other suitable engagement. Two or more elongate elements may be translatably or slidably connected or connectable with each other. Translatable elongate elements may optionally be non-pivotable relative to each other. In other words, an elongate element may be slidable along the longitudinal extent of another elongate element, preferably whilst connected thereto. A guide channel may be provided. Slidably-connected elongate elements may be enabled by a first said elongate element having a slidable engagement portion engageable with a complementary engagement portion of a second said elongate element.

If translatable, an elongate element may be lockable at a position along the longitudinal extent of a further elongate element by the locking element. The position may be selectable from a continuous range of positions, a subset of discrete positions, or there may be only one position in which the elongate elements may be locked, depending on the locking element.

In the first and third embodiments, the or each laser is a dot laser for projecting a dot or circle of light onto a target surface. However, any alternative to a dot laser may be envisioned. In the second embodiment, each laser projects a line. As an alternative, the laser may for example, be a pattern-projecting laser for projecting a pattern of light onto the target surface. A pattern of light may include any or any combination of: a cross, a circle, a polygon, any abstract shape, and a plurality of any of the above. A circle, a polygon, such as a square, rectangle, hexagon, or an abstract shape may be similar or identical to the shape of a fastener used to fix the fixture to the target surface.

In an alternative embodiment, a light emitting element may have a light-redirection element or portion in addition to or instead of a light emitting device. The light redirection element may include a reflective portion and/or a refraction portion. The reflective portion may include a mirror or reflective coating. A refraction portion may include a prism element and/or two or more abutted light-transmittive materials having different refractive indices, by way of example. The light redirecting element may receive a beam of, optionally laser, light and redirect at least a portion of the beam. One or more mirrors may optionally be mounted onto an actuator such that the mirrors may be repositionable for redirecting a light beam.

Whilst each light emitting element in the first embodiment is preferably slidably engageable with and/or slidably repositionable, and more preferably manually slidably repositionable along a rail element, alternative engagements may be envisioned for all or any number of light emitting elements. An actuator, such as a motor, and more preferably a stepper motor, may be provided for enabling automated movement of light emitting element. A light emitting element may be clippable to a rail element. The rail element may have at least one recess or opening into which at least part of a light emitting element is insertable. The rail element may have at least one projection onto which at least part of a light emitting element may be positioned or held in position. A fastener may be provided for connecting the light emitting element with the rail.

In an alternative embodiment, the secondary light emitter and/or tertiary light emitter may be received at least in part in the rail element and/or cavity. The cavity may optionally comprise at least one further opening. The secondary light emitter and/or tertiary light emitter may extend through the or a said further opening. Additionally or alternatively, light from the secondary light emitter and/or tertiary light emitter may be emitted through the or a said further opening.

Instead of or in addition to providing a scale along a longitudinal extent, a scale may be provided along a lateral extent or width of an elongate element and/or rail. A protractor or protractor-like element may be provided at or adjacent to a pivot point. A further modified embodiment may comprise a string, chain, or wire limiting the maximal distance or extent a light emitting element and/or elongate element may move, by way of example only.

Any alternative to a spirit-level may be envisioned such as a reed level, a laser line level, a water level, a plumb line, a digital levelling device, and/or any alternative means of measuring or checking how horizontal and/or vertical the guide apparatus may be. The guide apparatus or any part thereof may include or be mounted onto at least one gimbal.

Although the ground-engagement portions are short linear projections, elongate and/or non-linear ground-engagement portions may be an option. A ground-engagement portion may be curved or part curved in any of: longitudinal, lateral, and transverse cross-section, by way of example.

Whilst each ground-engagement portion is preferably integrally formed with the body, any or all ground-engagement portions may be non-integrally formed with the body. For instance, a ground-engagement portion may be connected or connectable thereto. A guide apparatus having removably connectable ground-engagement portion may be easier to store and/or transport. A removable connection may be provided by complementary screw threaded portions, a fastener arrangement, a boltable arrangement, slidable engagement portions, a bayonet engagement, or any other suitable engagement means or mechanism. Whilst each ground-engagement portion is preferably fixed relative to the body, movable relative thereto may be an option. For instance, each ground-engagement portion may be hingeably connected to the body. This may enable feet to be folded away, such as against or towards the body, when not in use. The compactness of the guide apparatus may be increased.

In a further modification, each ground-engagement portion may have an adjustable height for enabling adjustment of the pitch of the support body and/or of an elongate element. This may be useful if the ground or a surface to which the guide apparatus is connected is uneven and/or non-horizontal, for example. The height adjustment may be manual and/or automated. Such a ground-engagement portion may have telescopic portions, or selectively engageable subportions, by way of example. The ground-engagement portion may include one or more suction cups. If height adjustment is automated, the apparatus may further comprise one or more actuators, such as motors. The motors may be within the frame. The ground-engagement portion may additionally or alternatively to an anti-slip portion comprise one or more wheels, such as castor or roller wheels for facilitating positioning or repositioning of the apparatus.

In any of the above embodiments, the apparatus may comprise a user-interface. The user-interface may be communicable, such as via an emitter, receiver or transceiver, with a remote control and/or a personal computing device, such as a smartphone. A software application installed on the personal computing device and/or the remote control may enable a user to provide an input, and/or receive an output therefrom. The input may include a command to control an actuator or motor of the apparatus. The input may include data relating to the dimensions of the room in which the target surface is located. The input may include data relating to dimensions of the fixture to be mounted onto the target surface. Real-time data may be provided that may be used to calibrate the position of any of: the apparatus, an elongate element, a light emitting element, an actuator, any other portion of an apparatus, and any combination thereof.

In the shown embodiments, the fixture is an air-conditioning unit but any alternative fixture may be envisioned. Alternative fixtures may include a shelf, a cupboard, a light, a lighting-arrangement, a chandelier, a mosquito net, a mobile, a heating unit, fire alarm, carbon monoxide alarm, a fire extinguishing system, curtains, curtain rail, hand rail, a coat rack, a painting, a mirror, a radiator, or any other ornament.

Although each light emitting element is preferably electrically energisable by a power-connection which is preferably a conductive brush arrangement, alternative power-connections may be envisioned. At least one light emitting element may comprise an inductive charging member. A rail element may have a complementary inductive charging member or inductive charging contact portion such that the light emitting element may be electrically energisable by the rail element via induction. Although the term “contact portion” may be used, it is understood that there may be no direct contact in the case of induction. In another alternative, at least one light emitting element may comprise a portable power source, such as a battery. At least one light emitting element may be connected or connectable by a wire, cable, or other electrical conduit to the or a power source. Although the locking element preferably includes one or more clips in the first embodiment, the locking element may additionally or alternatively include any alternative locking element. This alternative may include an abutment element or stop. A stop may include a protrusion, such as a peg, and/or a recess. The locking element may include a bar or pole extending from at least one and/or between a plurality of elongate elements. The locking element may include a pin, screw, bolt or other fastener insertable into a recess or aperture in one or more elongate elements. A standard lock may be provided. An elasticated element or portion, such as an elastic band, may be used to maintain the body in a specific configuration and/or bias the body towards a specific configuration, for instance if the body is displaced from the said specific configuration. The locking element may include a movable portion which is movable or actuatable between a locking configuration and an unlocked configuration. The movable portion may include a projection or pad which can selectively bear against an elongate element to prevent or inhibit movement by friction. Whilst each clip element preferably has a right angle, any non-right-angle may be envisioned. The clip element and/or the wedge may have, for example, an acute angle and/or an obtuse angle. The angle may be between 10° and 170° although outside of this range may be an option. More preferably, the angle may be between 20° and 160° and even more preferably, between 30° and 150°. The angle may have any value, such as 20°, 25°, 30°, 40°,45°, 50°, 55°, 60°, 65°, 70°, 75°, 80°, 85°, 90°, 95°, 100°; 110°, 120°,130°, 140°, 150°,160°. For example, a clip element having a 120° angle may be useful for a body 12 having a regular hexagonal shape, by way of example only.

The locking device may enable a light emitting element to be selectably immobilised. Such a locking device may include a detent, a ratcheting member, a magnet, a pin-in-hole arrangement, a knob screw which can be moved to bear against a surface such as the rail.

Whilst a preferred shape may have been specified for any of the above-described any alternative shape may be envisioned in any of: lateral cross-section, longitudinal cross-section, in side view, in plan view. The alternative shape may be any or any combination of: curved, part curved, non-curved, linear, part linear, non-linear, a broken line, any polygon, whether regular or irregular, having one or more chamfered and/or rounded corners, a triangle, a quadrilateral, such as a square, a rectangle, a trapezium, a trapezoid, a pentagon, a hexagon, a heptagon, an octagon, or any other polygon, a cross, an ellipse, a circle, part circular, an oval, or any abstract shape.

Whilst the target surface or mounting surface is preferably a ceiling, the target surface may be any alternative surface, such as a wall. The target surface may be horizontal or substantially horizontal and/or non-horizontal. The target surface may be vertical or substantially vertical.

Features and caveats in any one of the above embodiments may be provided in any further one of the described embodiments.

It is therefore possible to provide a guide apparatus comprising: a support body which is optionally adjustable in at least two dimensions; and a plurality of light emitting elements which may be selectably positionable and/or reorientable on the support body, so that the position of an opening and/or a plurality of non-overlapping fixture mounting points can be simultaneously identified on a mounting surface via the light emitting elements. It is therefore also possible to provide a method of indicating the position of mounting points for fixture attachments on a mounting surface, the method comprising the steps of: a] providing a guide apparatus having repositionable light emitting elements; b] positioning the light emitting elements relative to each other and/or relative to the body so that the position of an opening is projected and/or the two-dimensional spatial distribution of the light emitted matches the spatial distribution of the attachment points of a fixture to be mounted onto the mounting surface; c] positioning the guide apparatus and activating the light emitting elements to emit light so that each light emitting element projects light onto the mounting surface. In both cases, the installation process is simplified due to no or less measuring by the user being required. As all mounting points are displayed simultaneously on the mounting surface, the steps of descending a ladder, checking a measurement, and ascending the ladder may be omitted. Installation of the fixture is therefore faster and less physical effort. The position of an opening, such as for a door or a window, may additionally or alternatively be projected.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof. It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. The embodiments described above are provided by way of examples only, and various other modifications will be apparent to persons skilled in the field without departing from the scope of the invention as defined herein.

1. A guide apparatus comprising a support body; an actuator associated with the support body; controller; a plurality of light emitting elements connected to the support body and at least one of the light emitting elements being movable by the at least one actuator relative to the support body, each light emitting element can emit a beam of light onto a target surface, so that the position of an opening and/or of a plurality of non-overlapping fixture mounting points can be simultaneously projected on the target surface by the light emitting elements.

2. The apparatus as claimed in claim 1, wherein the actuator includes a pivot axis around which the actuator is pivotable such that the at least one light emitting element is pivotably movable relative to the support body.

3. The apparatus as claimed in claim 1, wherein the actuator further includes an arcuate edge and a wheel engageable with the arcuate edge.

4. The apparatus as claimed in claim 1, wherein the actuator includes an actuator portion which is pivotable around at least two non-parallel and non-colinear pivot axes such that the least one light emitting element is rotatably movable in a plurality of dimensions relative to the support body.

5. The apparatus as claimed in claim 1, wherein the support body further comprises a movable support element to which at least one light emitting element is mounted.

6. The apparatus as claimed in claim 5, wherein the apparatus further comprises a further actuator, the movable support element being movable by the further actuator.

7. The apparatus as claimed in claim 1, wherein the controller comprises a calculating element and/or wherein the apparatus further comprises at least one of: a height-measurement device, and a distance measurement device

8. (canceled)

9. The apparatus as claimed in claim 7, wherein the distance-measurement device includes at least two distance sensors.

10. The apparatus as (110) claimed in claim 9, wherein each distance sensor of the at least two distance sensors has a distance-finding axis and the distance-finding axes of at least two of the distance sensors are parallel.

11. The apparatus as claimed in claim 1, wherein the apparatus further includes a user-interface.

12. The apparatus as claimed in claim 11, wherein the user-interface includes a screen.

13. The apparatus as claimed in claim 1, wherein at least two light emitting elements each have a light emitting device, each light-emitting device has a light emitting aperture that is elongate along an aperture axis.

14. A method of indicating the position of an opening and/or the position of mounting points on a target surface, the method comprising the steps of: a] providing a guide apparatus having repositionable light emitting elements and an actuator; and b] positioning the guide apparatus on a surface, positioning and/or orienting at least one of the light emitting elements via the actuator so that the position of an opening is indicated by beams of light and/or the two-dimensional spatial distribution on the target surface of a plurality of non-overlapping fixture mounting points indicated by beams of light emitted by the light emitting elements matches a spatial distribution of the attachment points of a fixture to be mounted onto the target surface, and activating the light emitting elements to emit light so that each light emitting element projects light onto the target surface.

15. A fixture-installation guide apparatus comprising:
a dimensionally-adjustable support body which is adjustable in at least two dimensions; and
a plurality of light emitting elements which are selectably positionable on the dimensionally-adjustable support body, each light emitting element can emit a beam of light onto a mounting surface, so that the position of a plurality of non-overlapping fixture mounting points can be simultaneously projected on the mounting surface by the light emitting elements.

16. A fixture-installation guide apparatus as claimed in claim 15, wherein the dimensionally-adjustable support body comprises a plurality of elongate elements connected to each other and movable relative to each other and wherein at least two elongate elements each comprise a rail element, and at least one of the said light emitting elements is receivable in or on each rail element.

17. A fixture-installation guide apparatus as claimed in claim 16, wherein at least one said rail element comprises a contact element which is electrically energisable and at least one said light emitting element is powered via the contact element, at least one said light emitting element further comprising a conductive brush and/or at least one said light emitting element comprises an inductive charging member.

18. A fixture-installation guide apparatus as claimed in claim 16, wherein at least two of the said plurality of elongate elements are connected to each other at a pivot point such that said at least two elongate elements are pivotably movable relative to each other to enable the support body to be adjustable in at least two dimensions.

19. A fixture-installation guide apparatus as claimed in claim 16, wherein the said plurality of elongate elements comprises four elongate elements pairwise pivotably connectable with each other, forming at least a first pivot point, a second pivot point, a third pivot point and a fourth pivot point and/or further comprising a pivot-point guide channel along which any of: the pivot point, the first pivot point, the second pivot point, the third pivot point and the fourth pivot point is slidable, the pivot-point guide channel being provided on any elongate element of the said plurality of elongate elements.

20. A fixture-installation guide apparatus as claimed in claim 16, wherein a first elongate element of the said plurality of elongate elements has a slidable engagement portion engageable with a complementary engagement portion of a second elongate element of the said plurality of elongate elements such that the first and second elongate elements are translatable relative to each other to enable the support body to be adjustable in at least two dimensions.

21. A fixture-installation guide apparatus as claimed in claim 15, further comprising at least one of: a spirit-level provided in or on the support body and/or in or on a light emitting element; a ground-engagement portion comprising an anti-slip portion, a secondary light emitting element, able to project a light beam perpendicularly to a light beam from a light emitting element of the said plurality of light emitting elements; a tertiary light emitting element, able to project a light beam perpendicularly relative to a light beam from both the secondary light emitting element and a light emitting element of the said plurality of light emitting elements, and a measurement portion.

22. (canceled)
